(19) United States
(12) Patent Application Publication
(10) Pub. No.: US 2026/0044358 A1
(43) Pub. Date: Feb. 12, 2026

(54) DEVICE AND METHOD FOR OPERATING CHATBOT PERFORMING ROLE OF ARTIFICIAL INTELLIGENCE TEACHER

(71) Applicant: Firsthabit Co.,Ltd., Seoul (KR)

(72) Inventor: Jung Woo KANG, Seoul (KR)

(73) Assignee: Firsthabit Co.,Ltd., Seoul (KR)

(21) Appl. No.: 19/295,205

(22) Filed: Aug. 8, 2025

(30) Foreign Application Priority Data
Aug. 12, 2024 (KR) 10-2024-0107541

(51) Int. Cl. G06F 9/451; H04L 51/02

(52) U.S. Cl. CPC G06F 9/453; H04L 51/02

(57) ABSTRACT

A device and method are provided for operating chatbot performing the role of an artificial intelligence teacher. The chatbot determines style information corresponding to a user-preferred teaching style by analyzing features from lecture data. The method outputs question data related to a predefined question to a user terminal and receives request for help data from the user. Based on the request for help, the chatbot generates a sequential guide to help the user reach the correct answer. The guide is customized according to the determined teaching style, allowing the chatbot to simulate interactive, adaptive instruction in a manner consistent with the selected persona.

### CROSS-REFERENCE TO RELATED APPLICATION

This application claims priority under 35 U.S.C. § 119 to Korean Patent Application No. 10-2024-0107541 filed on Aug. 12, 2024, in the Korean Intellectual Property Office, the entire contents of which are hereby incorporated by reference.

### BACKGROUND

### Technical Field

The disclosure relates to a device and a method for operating a chatbot that can provide a user with sequential and deductive queries to reach an answer by generating a persona of a teacher who has a teaching style desired by the user out of teachers who conduct online classes and then using the generated persona.

### Description of the Related Art

The content set forth in this section merely provides background information on the present embodiments and does not constitute prior art.

As chatbot services have recently become prevalent, instances in which services utilizing chatbots are provided in various industries are on the rise. Chatbot services have the advantage of being able to guide users with necessary information without time or space constraints.

In line with this industrial environment, technologies for providing learners with the necessary information by utilizing chatbots have recently been developed in the field of education as well.

However, commonly available learning and education chatbots are nothing but the ones that simply provide answers to questions or, that output data on a particular topic in response to a question when a user asks the question on the topic.

To elaborate, conventional educational chatbots lack the ability to diagnose conceptual gaps in a user's knowledge and respond with instructional content tailored to the user's learning style. As a result, such systems merely return static responses, lacking the interactivity, adaptability, and contextual awareness required for effective education. Additionally, existing systems do not leverage real-world pedagogical data to simulate instructor behavior or engage in sequential reasoning.

Furthermore, existing educational chatbot systems fail to address critical technical limitations related to user modeling, natural language understanding, and responsive instruction generation. As noted above, these systems are typically rule-based and static, lacking the technical mechanisms required to adapt to a user's evolving knowledge state or to simulate nuanced instructional methods as found in real-world pedagogical environments. As such, they are unable to facilitate concept-based learning through deductive dialogue or simulate human instructor behavior in a technically robust manner.

Accordingly, there exists a sufficient need for an education-related chatbot that can perform specific interactions with users, such as asking and responding, just like real teachers present at schools or academies, i.e., a chatbot that can serve as an AI (artificial intelligence) teacher.

### BRIEF SUMMARY

The disclosed system provides an artificial intelligence based educational chatbot that generates personalized teaching personas by analyzing real-world lecture data. It uses pre-trained neural networks to extract features such as speaking style, instructional methods, and engagement patterns from online lectures conducted by different teachers. These features are converted into teacher style vectors and compared with a user's indicated preference using cosine similarity. The closest matching style is selected to create a chatbot persona that communicates in the manner preferred by the user, including aspects such as tone, vocabulary, and teaching approach.

Unlike conventional educational chatbots that deliver direct answers, this system supports learning by guiding users through sequential and deductive reasoning. It compares the question and its corresponding solution with a predefined concept set and concept hierarchy to identify the knowledge areas involved. When a user requests assistance, the system identifies specific knowledge gaps by analyzing the request and generates either targeted prompts to encourage problem solving or explanatory material. Depending on the user's responses, the system may adjust the guidance to address related or broader concepts, always maintaining consistency with the selected teacher persona.

The overall structure uses separate neural network modules that are trained with labeled lecture data to extract and model teacher-specific characteristics. This modular training approach supports the accurate simulation of teaching styles and allows for responsive, real-time educational support. The combination of teacher behavior modeling, concept-based reasoning, and adaptive guidance contributes to a comprehensive educational tool that offers customized learning support based on both user needs and instructional style.

Various embodiments of the present disclosure provide a device and a method for operating a chatbot that performs the role of an AI teacher.

Various embodiments of the present disclosure provide a device and a method for operating a chatbot that can customize response methods to individual users by generating a persona of a teacher who has a teaching style desired by a user out of teachers who conduct online classes and then responding to a query of the user using the generated persona.

Various embodiments of the present disclosure to provide a device and a method for operating a chatbot that can provide sequential and deductive queries so that a user can autonomously reach an answer to a question, beyond simply providing the answer to the question or outputting the answer to the query of the user.

The technical benefits of the present disclosure are not limited to those mentioned above, and other benefits and advantages of the present disclosure that have not been mentioned can be understood by the following description and will be more clearly understood by the embodiments of the present disclosure. Furthermore, it will be readily appreciated that the objects and advantages of the present disclosure can be realized by the means set forth in the claims and combinations thereof.

According to some aspects of the disclosure, a chatbot operation method performed by a chatbot operation device includes determining style information related to a style of responding to a query of a user; outputting question data related to a predefined question to a user terminal corresponding to the user; receiving request for help data related to the question data from the user terminal; and generating a sequential guide for the user to reach answer data corresponding to the question data based on the request for help data, and providing the generated sequential guide according to the style information.

Furthermore, the determining the style information includes generating teacher analysis data for each of a plurality of teachers conducting online lectures based on lecture data related to the online lectures; receiving a desired style, which is a style desired by the user, from the user terminal; and determining the style information based on the teacher analysis data and the desired style.

Additionally, the determining the style information based on the teacher analysis data and the desired style calculates a cosine similarity between each of the plurality of teacher analysis data and the desired style, and determines teacher analysis data having a maximum calculated cosine similarity as the style information.

Moreover, the generating the teacher analysis data includes generating the teacher analysis data by analyzing features of a teacher conducting the online lecture by using a pre-trained neural network.

The generating the teacher analysis data by analyzing the features of the teacher includes extracting conversational features related to a voice of the teacher based on the lecture data; extracting description features related to a delivery method of lecture content of the teacher based on the lecture data; extracting entertainment features related to a level of entertainment of the teacher based on the lecture data; and determining at least one of the conversational features, the description features, and the entertainment features as the teacher analysis data.

The providing the sequential guide according to the style information includes generating required information related to concepts required to solve the question by comparing the question data with solution data related to an answer to the question; determining some of the generated required information as deficiency information related to concepts the user lacks based on the request for help data; generating the sequential guide based on the deficiency information; and providing the sequential guide according to the style information.

The generating the required information includes determining at least one concept of a plurality of concepts included in concept information including a predefined concept set and a concept tree as the required information by comparing the question data with the solution data.

The determining some of the generated required information as the deficiency information related to the concepts the user lacks includes determining concepts corresponding to keywords included in the request for help data out of at least one piece of the required information as the deficiency information.

The providing the sequential guide according to the style information includes providing query data regarding whether the user is familiar with the deficiency information to the user terminal; and providing, to the user terminal, first guide data that guides the user to solve the question data by using the deficiency information or second guide data that provides a description of the deficiency information, based on a response by the user terminal to the query data.

The providing the second guide data to the user terminal includes providing, to the user terminal, content data describing at least one of the deficiency information, a higher-level concept of the deficiency information, and a similar concept to the deficiency information.

The device and the method for operating a chatbot according to some embodiments of the present disclosure can provide a user with a customized solution, such as an AI teacher, by analyzing online and offline content and systems.

Further, the device and the method for operating a chatbot according to some embodiments of the present disclosure can provide a user with communication according to the style of a teacher desired by an individual by analyzing the styles of a plurality of teachers conducting online classes, then generating a persona of a teacher having a teaching style desired by the user out of the plurality of teachers, and determining a method of responding to a query of the user using the generated persona.

Moreover, the device and the method for operating a chatbot according to some embodiments of the present disclosure have a novel effect of being able to provide sequential and deductive queries so that a user can autonomously reach an answer to a question, beyond simply providing the answer to the question or outputting the answer to the query of the user.

The disclosed device, method, and system addresses these challenges by implementing a technical architecture that includes neural-network-based teacher analysis, embedding-based concept comparison, and sequential reasoning engines. This enables the chatbot to perform real-time analysis of user queries, infer user knowledge states, and deliver deductive guidance in a dynamically personalized instructional style. These elements work in concert to achieve a practical improvement in human-computer interaction for educational purposes and represent a specific technical solution to the problem of static, non-adaptive chatbot behavior.

In addition to the foregoing description, specific effects of the present disclosure will be stated together while describing specific details for implementing the present disclosure below.

### BRIEF DESCRIPTION OF THE SEVERAL VIEWS OF THE DRAWINGS

FIG. 1 shows a chatbot operation system according to some embodiments of the present disclosure.

FIG. 2 is a diagram for describing the structure of the neural network according to some embodiments of the present disclosure.

FIG. 3 is a block diagram of the chatbot operation device according to some embodiments of the present disclosure.

FIGS. 4a to 4c are views for describing the lecture data, the teaching material data, and the concept information, respectively, according to some embodiments of the present disclosure.

FIG. 5 is a flowchart of a chatbot operation method according to some embodiments of the present disclosure.

FIG. 6 is a detailed flowchart of the step of determining the style information of FIG. 5.

FIGS. 7a to 7d are diagrams for describing steps of generating teacher analysis data according to some embodiments of the present disclosure.

FIG. 8 is a diagram for describing a step of outputting question data and a step of receiving request for help data according to some embodiments of the present disclosure.

FIG. 9 is a detailed flowchart of a step of providing the sequential guide of FIG. 5 according to the style information.

FIGS. 10a to 10f are diagrams for describing a process of providing the sequential guide according to the style information in accordance with some embodiments of the present disclosure.

FIG. 11 is a diagram for describing a hardware implementation of a chatbot operation device that performs a teaching material analysis method according to some embodiments of the present disclosure.

### DETAILED DESCRIPTION

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc., used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc., should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

The present disclosure addresses limitations in conventional chatbot systems by providing a concrete technical architecture that improves the functioning of interactive educational systems. Unlike existing approaches that rely on fixed rule sets, template-driven dialogue, or manually programmed personas, the disclosed system employs a multi-stage artificial intelligence framework that enables personalized, dynamic, and pedagogically coherent interaction. The system improves computer-based tutoring by introducing mechanisms for real-time adaptation based on both the instructional style of real-world teachers and the evolving understanding of the user.

Specifically, the system extracts multi-dimensional features from actual lecture content, including conversational patterns, instructional techniques, and indicators of user engagement. These features are obtained using supervised and unsupervised learning algorithms operating on audio, video, and textual inputs. For example, the system can identify whether a teacher uses a storytelling or exemplification-based delivery method, whether they use formal or colloquial speech, and whether their teaching style includes humor or expressive emphasis. These features are encoded into structured vectors representing individual instructor profiles, which are then compared to a user's expressed preferences using similarity metrics, such as cosine similarity. This comparison allows the system to select or synthesize a chatbot persona that closely matches the user's desired style, enabling more effective and user-centered interaction.

In parallel, the system maps question data and solution data into a shared vector space aligned with a predefined domain-specific concept hierarchy. This is achieved using embedding models such as BERT or Siamese networks, which transform semantically significant elements from the input data into dense vector representations. The system then compares these vectors to identify the set of concepts necessary to solve the presented problem. When the user submits a request for assistance, the system analyzes the input to extract linguistic features that indicate conceptual uncertainty, which are then cross-referenced with the identified required concepts to determine the user's specific knowledge gaps.

Based on this analysis, the system generates a structured guidance sequence designed to help the user reach the solution autonomously. This may involve a series of prompts, scaffolding questions, or concept explanations, which are tailored to the user's current level of understanding. Critically, all responses—including deductive hints and instructional content—are rendered in the language and manner of the selected instructional persona. The result is a system that not only adjusts the content of its responses based on user knowledge state but also adjusts the form of those responses to reflect a realistic and pedagogically effective teaching style.

These operations represent more than mere abstract processing of information. They embody a concrete improvement in the technical operation of computer-implemented tutoring systems, including enhancements to user modeling, real-time decision-making, vector-space data correlation, and natural language generation. The integration of machine-learned style modeling with concept-aware instructional sequencing enables the chatbot to function more like a human tutor in both form and substance, offering a technical solution to the rigid, unengaging, and ineffective interactions characteristic of prior systems.

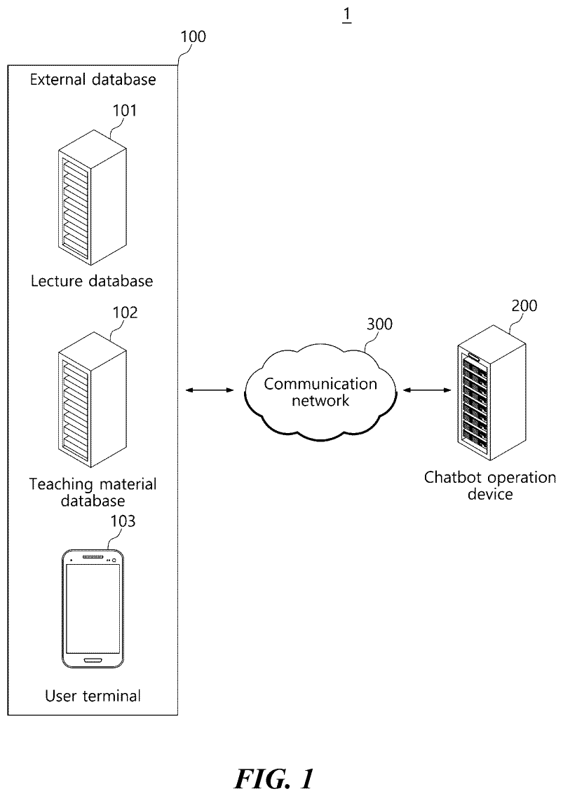

Hereinafter, a device and a method for operating a chatbot and a chatbot operation system including the same according to some embodiments of the present disclosure will be described with reference to FIGS. 1 to 11.

FIG. 1 shows a chatbot operation system according to some embodiments of the present disclosure.

Referring to FIG. 1, the chatbot operation system 1 may include an external database 100, a chatbot operation device 200, and a communication network 300.

The external database 100 is a database that transmits input data for chatbot operation to the chatbot operation device 200.

As some examples, the external database 100 may include a lecture database 101, a teaching material database 102, and a user terminal 103. However, the embodiment of the present disclosure is not limited thereto, and it is obvious that some of the lecture database 101, the teaching material database 102, and the user terminal 103 included in the external database 100 may be implemented in an integrated manner, or the external database 100 may include more types of objects.

The lecture database 101 may be a database that stores, manages, transmits, and outputs a plurality of online lectures. As one example, the lecture database 101 may provide online lectures to a web or app managed by an online lecture site, and the user terminal 103 or the like linked to the lecture database 101 may access the corresponding web or app and take online lectures. In this case, a user corresponding to the user terminal 103 may refer to a student who is taking or intends to take an online lecture. As another example, the lecture database 101 may transmit online lectures to the chatbot operation device 200. In other words, the lecture database 101 may provide lecture data related to online lectures to the chatbot operation device 200 in order for the chatbot operation device 200 to perform lecture analysis on each of a plurality of online lectures. In this case, the lecture data may include lecture content in an online lecture. For example, the lecture data may include video data obtained by capturing an online lecture, audio data obtained by recording the teacher's voice in the online lecture, etc., but the embodiment of the present disclosure is not limited thereto, and the lecture data may also include text data or image data for textbooks, lecture materials, etc., used in conducting the corresponding online lecture. Further, the lecture database 101 may be in the form of a workstation, a data center, an internet data center (IDC), a direct attached storage (DAS) system, a storage area network (SAN) system, a network attached storage (NAS) system, and a redundant array of inexpensive disks or a redundant array of independent disks (RAID) system, but the embodiment of the present disclosure is not limited thereto.

The teaching material database 102 is a database that stores, manages, analyzes, and saves teaching material data. The teaching material database 102 may transmit the teaching material data to the user terminal 103, the chatbot operation device 200, and the like. In this case, the teaching material data may include question data on predefined questions and solution data on the answers to the questions. However, the embodiment of the present disclosure is not limited thereto. Further, the teaching material database 102 may be in the form of a workstation, a data center, an internet data center (IDC), a direct attached storage (DAS) system, a storage area network (SAN) system, a network attached storage (NAS) system, and a redundant array of inexpensive disks or a redundant array of independent disks (RAID) system, but the embodiment of the present disclosure is not limited thereto.

The user terminal 103 refers to a terminal of a user who uses a chatbot provided by the chatbot operation device 200. In this case, the user terminal 103 may access a chatbot program in the form of a web or app provided by the chatbot operation device 200 and use the chatbot.

As one example, the user terminal 103 may receive question data provided by the chatbot operation device 200 and transfer request for help data entered by the user in response to the received question data to the chatbot operation device 200. In this case, the request for help data may be data with which the user requests help to solve a corresponding question. As another example, the user terminal 103 may receive a sequential guide to reach the answer data provided by the chatbot operation device 200 based on the request for help data, and transfer a response entered by the user or the like to the chatbot operation device 200 in response to the sequential guide.

In this case, the user terminal 103 may transfer style information related to the style in which the chatbot operation device 200 responds to a query of the user as desired by the user to the chatbot operation device 200 under the control of the user, and receive a response according to the style information from the chatbot operation device 200. In this case, the style of responding to the query of the user may include conversational features (e.g., speaking mannerism, vocabulary, use of standard language, etc.), description features (e.g., description method information, description sequence information, etc.), other entertainment features related to entertainment (e.g., level of jokes, etc.), and the like.

Further, the user terminal 103 may be in the form of various types of electronic devices such as a smartphone, a computer, a laptop PC, a wearable device, an IoT device, etc., but the embodiment of the present disclosure is not limited thereto.

The chatbot operation device 200 may output question data related to a predefined question to the user terminal 103, receive request for help data in response thereto, and then provide a sequential guide for the user to reach the answer to the question based on the request for help data to the user terminal 103. In this case, the chatbot operation device 200 may generate the sequential guide according to the style information specified by the user and provide it to the user terminal 103.

As some examples, the chatbot operation device 200 may generate the sequential guide according to the style information by using AI (artificial intelligence) technology. As one example, the chatbot operation device 200 may generate the sequential guide according to the style information by using a pre-trained neural network structure.

Describing in greater detail, a deep-learning technique, which is a kind of machine learning, goes down to a deep level and learns in multiple stages based on data. In other words, deep learning refers to a set of machine learning algorithms that extract core data from a plurality of data while moving up the stages.

As some examples, the neural network may use a variety of known deep learning structures. For example, the neural network may use structures such as a convolutional neural network (CNN), a recurrent neural network (RNN), a deep belief network (DBN), a graph neural network (GNN), a generative adversarial network (GAN), a transformer, and an auto-encoder.

Specifically, a CNN (convolutional neural network) is a model that simulates the function of the human brain, created based on the assumption that when a person recognizes an object, s/he extracts basic features of the object, then performs complex calculations in the brain, and based on the results, recognizes the object. The CNN may include, but is not limited to, known structures such as LeNet, AlexNet, VGGNet, GoogleNet, and ResNet.

An RNN (recurrent neural network) is widely used for natural language processing, etc., is a structure effective in processing time-series data that changes over time, and is capable of constructing an artificial neural network structure by stacking layers at every instant.

A DBN (deep belief network) is a deep learning structure constructed by stacking a restricted Boltzmann machine (RBM), which is a deep learning technique, in multiple layers. When a certain number of layers are obtained by repeating restricted Boltzmann machine (RBM) training, a DBN (deep belief network) having the corresponding number of layers can be constructed.

A GNN (graphic neural network, hereinafter, GNN) refers to an artificial neural network structure implemented in a way of deriving a similarity and feature points between modeling data by using the modeling data modeled based on data mapped between particular parameters.

A GAN (generative adversarial network, hereinafter, GAN) refers to an artificial neural network structure that creates new data in a similar form to the input data by using a generative neural network and a discriminative neural network. The GAN may include the known DCGAN (deep convolutional GAN), CGAN (conditional GAN), WGAN (Wasserstein GAN), StyleGAN (style-based GAN), CycleGAN, etc., but the embodiment of the present disclosure is not limited thereto.

A transformer is an artificial neural network in an encoder-decoder structure that utilizes attention, and allows for identifying the overall meaning between an input sequence and an output sequence. Transformers allow all elements of an input sequence to affect an output sequence by using an attention mechanism, and through this, both the encoder and decoder can take the entire sequence into account. Transformers can use not only natural languages and time series data but also images as input by patching them.

An auto-encoder is a deep learning structure that performs the role of extracting and reconstructing the features of data. Representatively, an auto-encoder includes an encoder that compresses input values and a decoder that reconstructs the compressed data. The encoder converts input values into lower-dimensional latent representations, and the decoder reconstructs the latent representations in the same dimension as the input values. In this case, the encoder and decoder may each be composed of a multilayer perceptron (MLP). When training an auto-encoder, input data is input, and weights and biases are used in the training in a direction of minimizing the difference between the output value and the input value. The auto-encoder trained as such can extract the features of input data well and reconstruct noisy input data. Auto-encoders are utilized mainly in the fields of data compression, dimensionality reduction, noise removal, data generation, etc., and can also be utilized in the fields of image recognition, natural language processing, speech recognition, etc.

Further, the training of the artificial neural network of the neural network may be achieved by adjusting the weights of the connecting lines between nodes (and also adjusting the bias values if necessary) so that a desired output is obtained for a given input. In addition, the artificial neural network can continuously update the weight values by training. Moreover, methods such as backpropagation may be used for training the artificial neural network.

In this case, unsupervised learning, semi-supervised learning, supervised learning, and the like may be used as the machine learning method of the artificial neural network. Furthermore, the neural network may be controlled to automatically update the artificial neural network structure for outputting analysis data after training according to settings.

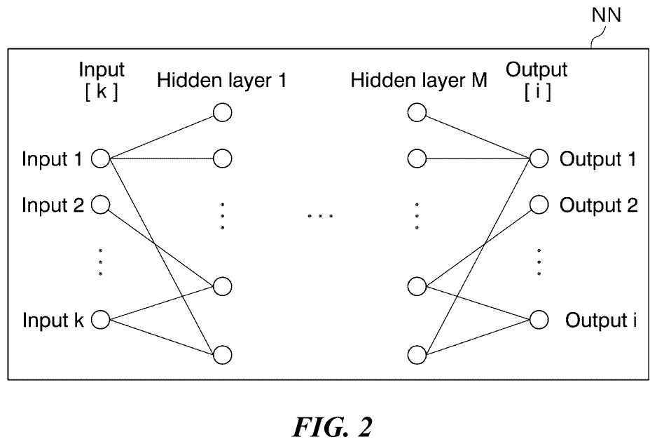

In the following, the neural network structure used by the chatbot operation device 200 according to some embodiments of the present disclosure will be described with reference to FIG. 2.

FIG. 2 is a diagram for describing the structure of the neural network according to some embodiments of the present disclosure.

Referring to FIGS. 1 and 2, the neural network (hereinafter referred to as “NN”) used by the chatbot operation device 200 according to some embodiments of the present disclosure may include an input layer Input, an output layer Output, and M hidden layers arranged between the input layer and the output layer.

Here, weights may be set for the edges that connect the nodes in the respective layers. The presence or absence of such weights or edges may be added, removed, or updated during the training process. Therefore, the weights of the nodes and edges arranged between k input nodes and i output nodes may be updated through the training process.

Before the neural network NN performs training, all nodes and edges may be set to initial values. However, if information is input cumulatively, the weights of the nodes and edges may be changed, and in this process, matching may be made between the parameters input as training factors and the values assigned to output nodes.

Additionally, if a cloud server is utilized, the neural network NN may receive and process a large number of parameters. Therefore, the neural network NN may perform training based on an immense amount of data.

The weights of the nodes and edges between the input and output nodes constituting the neural network NN may be updated by the training process of the neural network NN. Furthermore, the parameters input to or output from the neural network NN may be further expanded to various data.

Referring again to FIG. 1, the communication network 300 refers to a communication means that performs data exchange between the external database 100 and the chatbot operation device 200.

In this case, the communication network 300 may include a network based on wired Internet technology, wireless Internet technology, and short-range communication technology. The wired Internet technology may include, for example, at least one of a local area network (LAN) and a wide area network (WAN). The wireless Internet technology may include, for example, at least one of wireless LAN (WLAN), Digital Living Network Alliance (DMNA), Wireless Broadband (WiBro), World Interoperability for Microwave Access (WiMAX), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), and 5G New Radio (NR) technology. However, the present embodiment is not limited thereto. The short-range communication technology may include, for example, at least one of Bluetooth, Radio Frequency Identification (RFID), Infrared Data Association (IrDA), Ultra-Wideband (UWB), ZigBee, Near Field Communication (NFC), Ultra Sound Communication (USC), Visible Light Communication (VLC), Wi-Fi, Wi-Fi Direct, and 5G New Radio (NR). However, the present embodiment is not limited thereto.

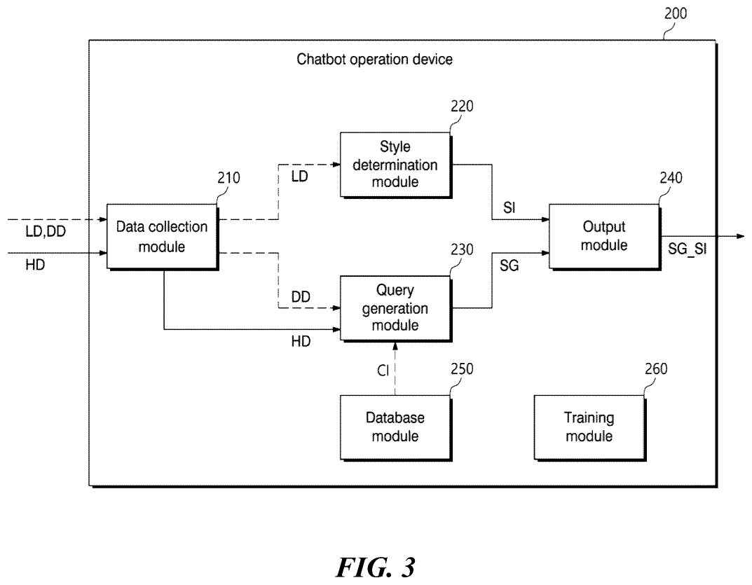

In the following, the structure and operation of the chatbot operation device 200 according to some embodiments of the present disclosure will be described in greater detail with reference to FIGS. 3 to 11.

FIG. 3 is a block diagram of the chatbot operation device according to some embodiments of the present disclosure.

Referring to FIGS. 1 and 3, the chatbot operation device 200 may include a data collection module 210, a style determination module 220, a query generation module 230, an output module 240, a database module 250, and a training module 260.

As some examples, the chatbot operation device 200 may determine style information (hereinafter referred to as “SI”) based on request for help data (hereinafter referred to as “HD”) received from the user terminal 103 by the data collection module 210, may generate a sequential guide (hereinafter referred to as “SG”) based on lecture data (hereinafter referred to as “LD”) received from the lecture database 101 and teaching material data (hereinafter referred to as “DD”) from the teaching material database 102 by the data collection module 210, and concept information (hereinafter referred to as “CI”) stored in advance in the database module 250, and may then provide the sequential guide SG_SI according to the style information to the user terminal 103.

In other words, the chatbot operation device 200 may generate the sequential guide SG_SI according to the style information based on the request for help data HD, the lecture data LD, the teaching material data DD, and the concept information CI.

The request for help data HD may be data with which the user requests help to solve a corresponding question. As one example, the request for help data HD may include text data entered by the user into the chatbot provided by the chatbot operation device 200 via the user terminal 103.

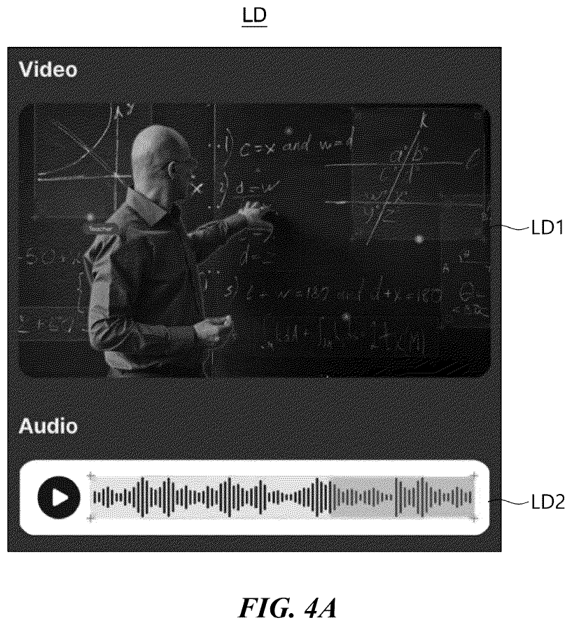

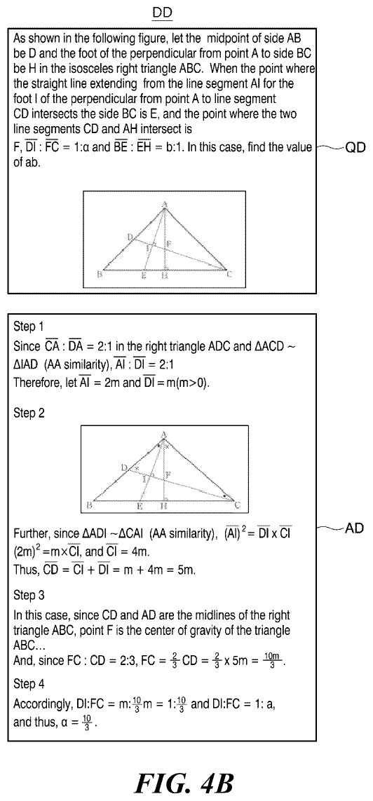

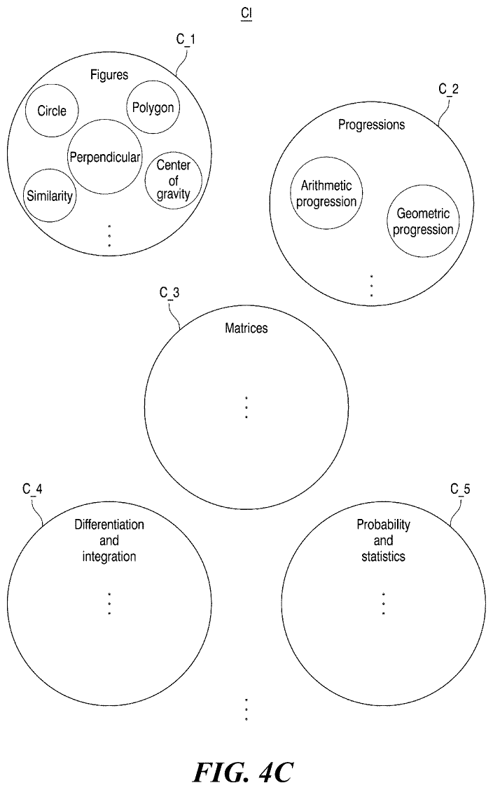

In the following, the lecture data LD, the teaching material data DD, and the concept information CI according to some embodiments of the present disclosure will be described with reference to FIGS. 4a to 4c.

FIGS. 4a to 4c are views for describing the lecture data, the teaching material data, and the concept information, respectively, according to some embodiments of the present disclosure.

Referring to FIG. 4a, the lecture data LD may include lecture content in an online lecture. For example, the lecture data LD may include video data obtained by capturing an online lecture, audio data obtained by recording voices in the online lecture, etc., but the embodiment of the present disclosure is not limited thereto, and the lecture data LD may also include text data or image data for textbooks, lecture materials, etc., used in conducting the corresponding online lecture.

The lecture data LD may include video data LD1 obtained by capturing an online lecture and audio data LD2 obtained by recording voices in the online lecture.

The video data LD1 may be video data obtained by capturing the progress of a class of a teacher via a filming device at the place of the class, a filming studio, etc. In this case, the video data may include the teacher's body, handwriting made by the teacher, lecture materials printed for conducting the class, and the like as objects.

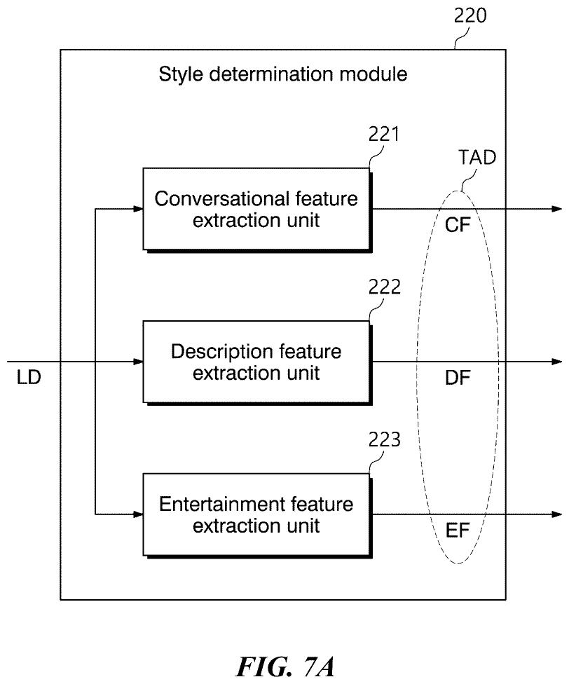

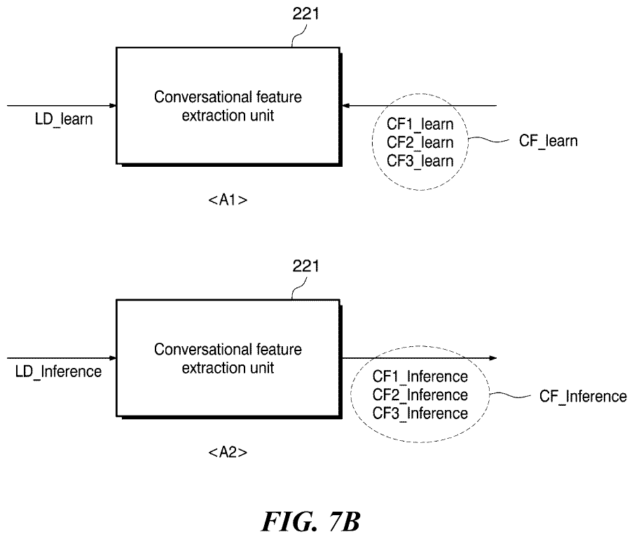

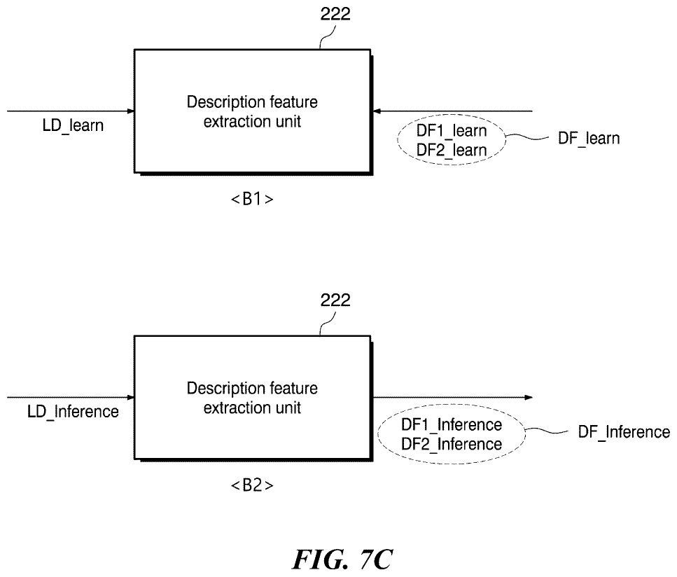

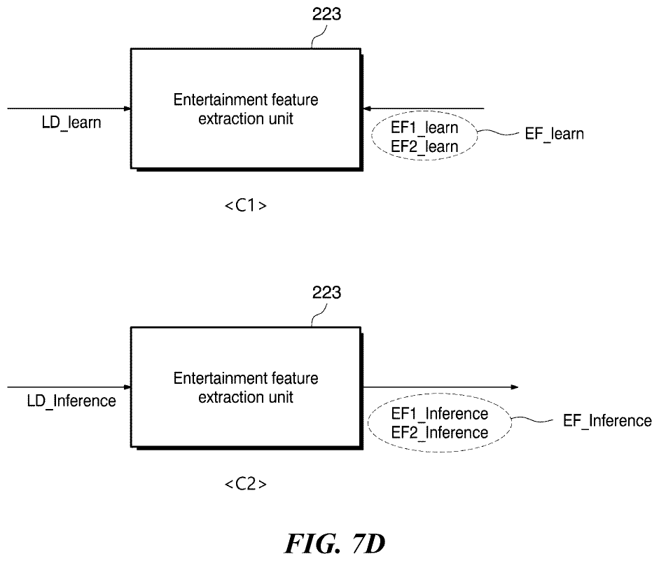

The audio data LD2 may be data containing the voice of the teacher in the corresponding lecture received via the filming device at the place of the class, the filming studio, etc., or received via a separate audio sensor or the like other than the filming device. In this case, the audio data LD2 may contain not only the voice of the teacher but also the voices of the students present at the place of the class or the filming studio, and these voices of the students may be used in the process of extracting entertainment features (EF in FIG. 7a) by an entertainment feature extraction unit (223 in FIG. 7a) described later.

Referring to FIG. 4b, the teaching material data DD may refer to data on questions and solutions present in a teaching material.

As some examples, the teaching material data DD may include question data (hereinafter referred to as “QD”) for predefined questions and solution data (hereinafter referred to as “AD”) related to answers to the corresponding questions. However, the embodiment of the present disclosure is not limited thereto.

The question data QD may refer to data on each of a plurality of questions included in the teaching material. In this case, the question data QD may include text data, image data, and the like, as shown in FIG. 4b, but the embodiment of the present disclosure is not limited thereto.

The solution data AD may be data on the answer to each of the plurality of questions included in the teaching material. In this case, the solution data AD may include information on the answer to a corresponding question, the process for deriving the answer, and the like. In this case, the solution data AD may include text data, image data, and the like, as shown in FIG. 4b, but the embodiment of the present disclosure is not limited thereto.

Referring to FIG. 4c, the concept information CI may include a plurality of concepts contained in textbooks, curricula, etc. In this case, the concept information CI may include a plurality of concepts distinguished by predefined types. As one example, the concept information may include a concept set containing a plurality of predefined concepts and/or a concept tree in which a plurality of concepts is ordered according to a predefined learning sequence and concept difficulty.

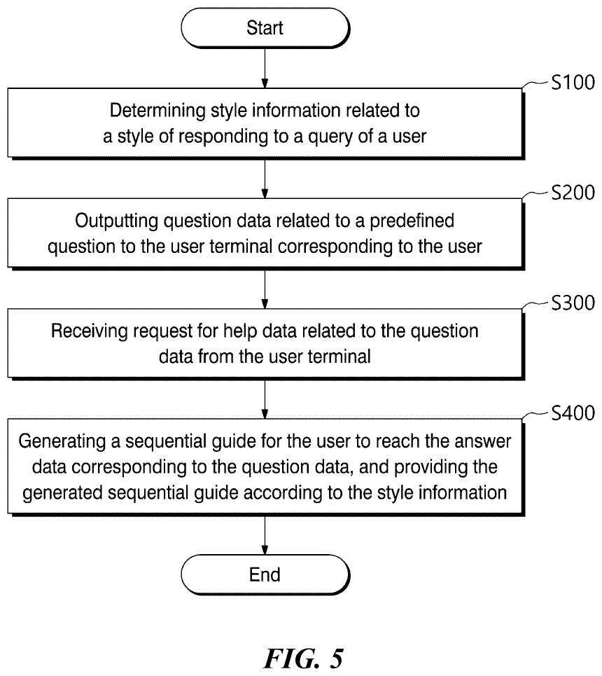

FIG. 4c shows, for convenience of description, that the concept information CI includes a first concept C_1 to a fifth concept C_5 related to the subject of “mathematics,” where the first concept C_1 is a concept related to “figures,” the second concept C_2 is a concept related to “progressions,” the third concept C_3 is a concept related to “matrices,” the fourth concept C_4 is a concept related to “differentiation and integration,” and the fifth concept C_5 is a concept related to “probability and statistics.” In this case, each concept C_1 to C_5 may include sub-concepts belonging to the corresponding concept, as shown in FIG. 5. For example, the first concept C_1 related to “figures” may include concepts of “circle, polygon, perpendicular, center of gravity, similarity of figures, and the like” and the second concept C_2 related to “progressions” may include concepts of “arithmetic progression, geometric progression, and the like.”

Referring again to FIGS. 1 and 3, the role of each component included in the chatbot operation device 200 will be described below.

The data collection module 210 may receive the lecture data LD, the teaching material data DD, and the request for help data HD as described above. As some examples, the data collection module 210 may receive the lecture data LD from the lecture database 101, the teaching material data DD from the teaching material database 102, and the request for help data HD from the user terminal 103. The data collection module 210 may transfer the lecture data LD, the teaching material data DD, and the request for help data HD to other components in the chatbot operation device 200. For example, the data collection module 210 may transfer the lecture data LD to the style determination module 220, and transfer the teaching material data DD and the request for help data HD to the query generation module 230. However, the embodiment of the present disclosure is not limited thereto.

The style determination module 220 may determine style information SI based on the lecture data LD. As one example, the style determination module 220 may generate teacher analysis data for each of a plurality of teachers conducting online lectures based on lecture data LD on a plurality of online lectures, and determine the style information SI based on the generated teacher analysis data and a desired style, which is a style desired by the user, from the user terminal 103. A detailed description thereof will be given later.

The query generation module 230 may generate a sequential guide SG for the user to reach the answer data corresponding to the question data according to the concept information CI, the teaching material data DD, and the request for help data HD. A detailed description thereof will be given later.

The output module 240 may combine the style information SI generated by the style determination module 220 and the sequential guide SG generated by the query generation module 230, generate a sequential guide SG_SI according to the style information, and output it to the user terminal 103 or the like.

The database module 250 may store the concept information CI. As one example, the database module 250 may store the concept information CI in advance as described above in FIG. 4c and transfer the concept information CI to the query generation module 230.

Further, the style determination module 220 and the query generation module 230 described above may be trained by the training module 260.

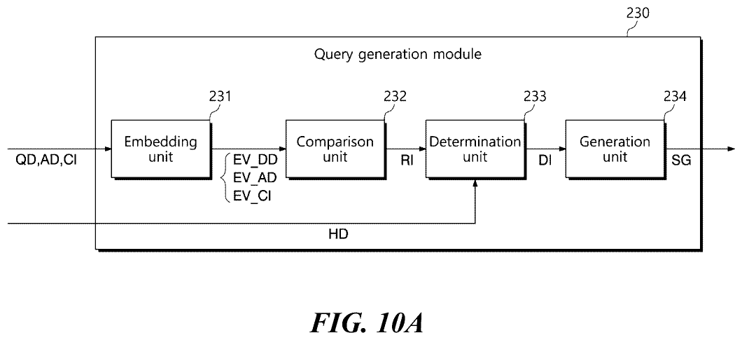

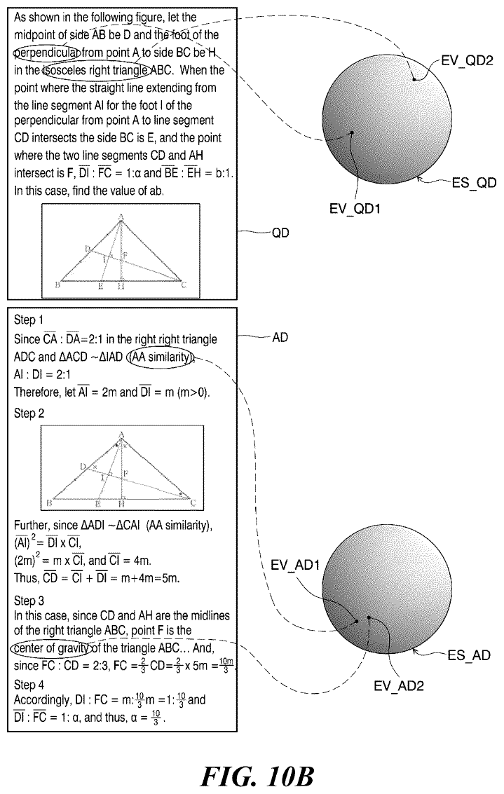

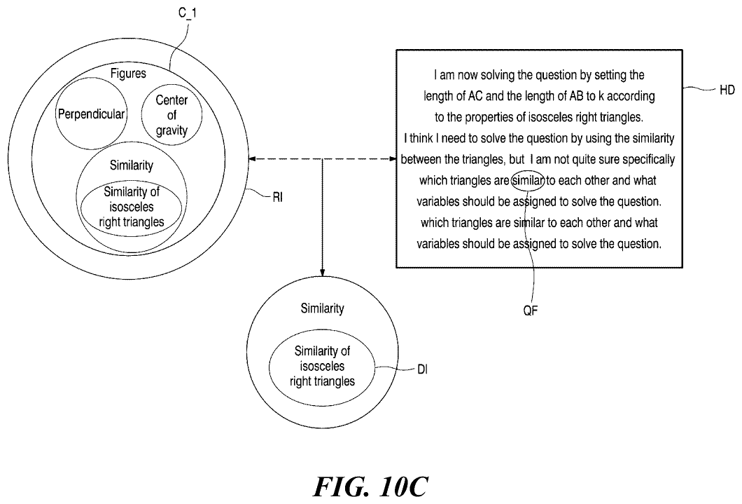

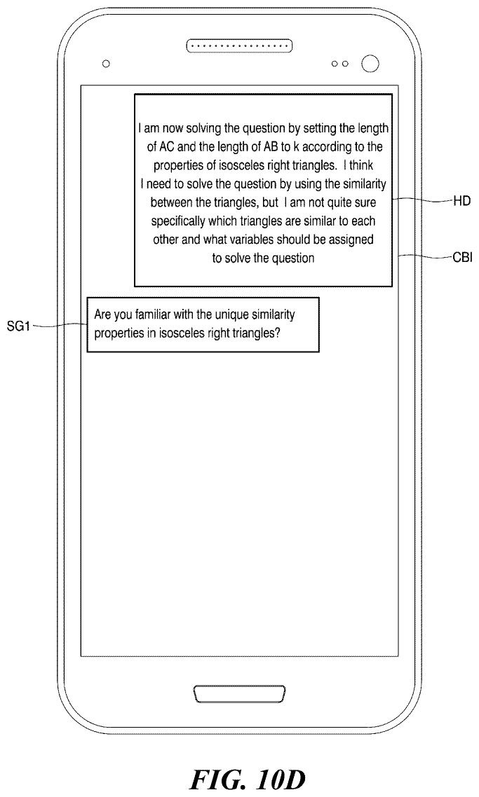

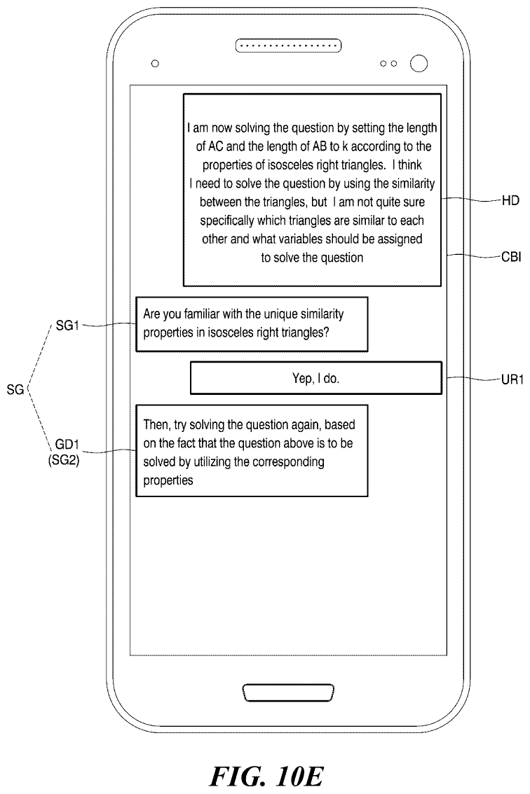

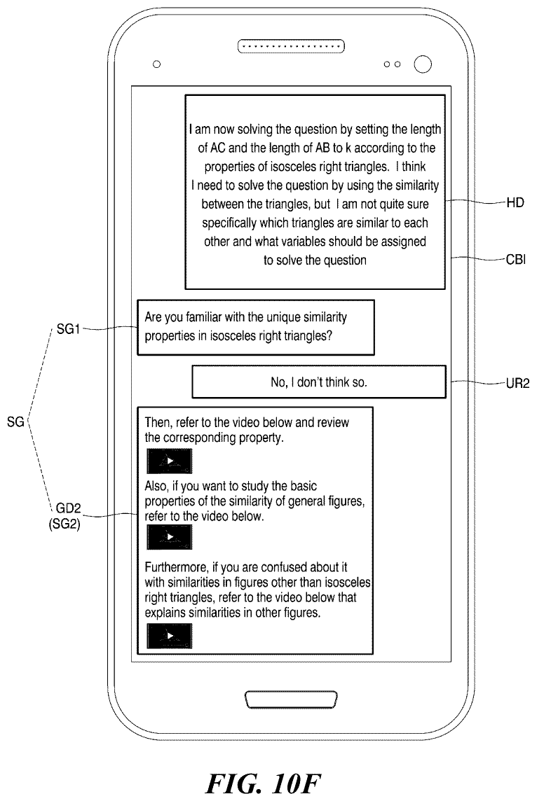

As some examples, the training module 260 may control the training of the neural networks (e.g., NN in FIG. 2) included in the style determination module 220 and the query generation module 230. In other words, the training module 260 may proceed with and control the training process of the style determination module 220 and the query generation module 230 by using predefined training data. In this case, the training module 260 may provide control signals for controlling the training of the style determination module 220 and the query generation module 230, labeling data used in the training process of the style determination module 220 and the query generation module 230, etc., to the style determination module 220 and the query generation module 230. As one example, the training module 260 may train a conversational feature extraction unit (221 in FIG. 7a), a description feature extraction unit (222 in FIG. 7a), and an entertainment feature extraction unit (223 in FIG. 7a) included in the style determination module 220, an embedding unit (231 in FIG. 10a) and a comparison unit (232 in FIG. 10a) included in the query generation module 230, and/or algorithms used by each component, or the like.

In the following, a process in which the chatbot operation device 200 according to some embodiments of the present disclosure generates the sequential guide SG_SI according to the style information will be described in steps with reference to FIGS. 5 to 11c.

FIG. 5 is a flowchart of a chatbot operation method according to some embodiments of the present disclosure. Each step (S100 to S400) of FIG. 5 may be performed by the chatbot operation device 200 of FIGS. 1 and 3.

Referring to FIGS. 1 and 3 to 5, first, the chatbot operation device 200 may determine style information SI related to a style of responding to a query of a user (S100).

As some examples, the style determination module 220 included in the chatbot operation device 200 may determine the style information SI based on lecture data LD.

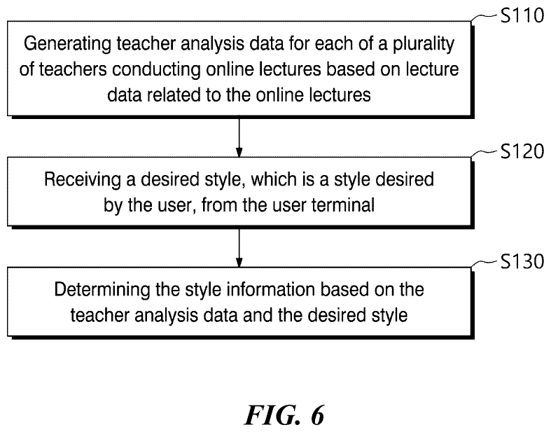

In the following, a process of determining the style information SI according to some embodiments of the present disclosure will be described with reference to FIGS. 6 to 7d.

FIG. 6 is a detailed flowchart of the step of determining the style information of FIG. 5. FIGS. 7a to 7d are diagrams for describing steps of generating teacher analysis data according to some embodiments of the present disclosure. Each step (S110 to S130) of FIG. 6 may be performed by the chatbot operation device 200 of FIGS. 1 and 3.

Referring to FIGS. 1 and 3 to 7c, first, the style determination module 220 may generate teacher analysis data (hereinafter referred to as “TAD”) for each of a plurality of teachers conducting online lectures based on lecture data LD related to the online lectures (S110).

As some examples, the style determination module 220 may generate the teacher analysis data TAD by analyzing the features of teachers conducting the online lectures by using a pre-trained neural network (e.g., NN in FIG. 2).

More particularly, the style determination module 220 may generate the teacher analysis data TAD through a step of extracting conversational features (hereinafter referred to as “CF”) related to the voice of a teacher based on the lecture data LD, a step of extracting description features (hereinafter referred to as “DF”) related to a delivery method of the lecture content of the teacher based on the lecture data LD, a step of extracting entertainment features (hereinafter referred to as “EF”) related to the level of entertainment of the teacher based on the lecture data LD, and a step of determining at least one of the conversational features CF, the description features DF, and the entertainment features EF as the teacher analysis data TAD.

The conversational feature extraction unit 221 may extract the conversational features CF of the teacher in the corresponding online lecture based on the lecture data LD. In this case, the conversational features CF may refer to features related to the voice uttered by the teacher in the corresponding online lecture. In this case, the conversational feature extraction unit 221 may extract the conversational features CF based on the audio data LD2 included in the lecture data LD.

As one example, the conversational features CF may include speaking mannerism of the teacher, vocabulary related to the words used by the teacher, whether the teacher uses a standard language, and the like. In other words, the conversational feature extraction unit 221 may extract at least one of speaking mannerism information of the teacher, vocabulary information related to vocabulary related to the words used by the teacher, and standard language information related to whether the teacher uses a standard language, as the conversational features CF.

The speaking mannerism information refers to the overall speaking style of the teacher when speaking in the online lecture. As one example, the speaking mannerism information may include the voice tone, speaking speed, presence or absence and degree of emotional expressions, etc., of the teacher. In this case, the speaking mannerism information may be categorized into a calm type, a soft type, an energetic type, a passionate type, etc.

The vocabulary information refers to the range and types of words used by the teacher. As one example, the vocabulary information encompasses the inclusion and degree of everyday words or specialized terms related to particular fields, etc. In this case, the vocabulary information may be categorized into an everyday vocabulary type, an intermediate vocabulary type, a specialized vocabulary type, etc. The standard language information refers to data related to whether the teacher uses a standard language. In this case, the standard language information may be categorized into a standard type, an intermediate type, a non-standard type (dialect type), etc. The pronunciation information may refer to data related to the pronunciation accuracy of the teacher. As one example, the conversational feature extraction unit 221 may extract the pronunciation information based on the clarity, level of clarity (e.g., noise ratio, SNR (signal-to-noise ratio), etc.), and the like in the interpretation of the audio data LD2 of the teacher. In this case, the pronunciation information may be categorized into an excellent type, an intermediate type, a poor type, etc.

FIG. 7b shows the learning phase and inferencing phase by the training module 260 of the conversational feature extraction unit 221. Specifically, <A1> of FIG. 7b shows the learning phase of the conversational feature extraction unit 221, and <A2> of FIG. 7b shows the inferencing phase of the conversational feature extraction unit 221.

As shown in <A1> of FIG. 7b, the conversational feature extraction unit 221 may be pre-trained by the training module 260 to output learning conversational features CF_learn based on learning lecture data LD_learn when the learning lecture data LD_learn is input. That is, the conversational feature extraction unit 221 may use the learning lecture data LD_learn and the learning conversational features CF_learn as a training data set in the learning phase.

The learning conversational features CF_learn may include learning speaking mannerism information CF1_learn, learning vocabulary information CF2_learn, and learning standard language information CF3_learn.

The learning conversational features CF_learn may be data input by a manager of the chatbot operation device 200. In other words, the learning conversational features CF_learn may be data input by the manager of the chatbot operation device 200 so as to match the lecture data LD_learn as learning data. In this case, the learning speaking mannerism information CF1_learn, the learning vocabulary information CF2_learn, and the learning standard language information CF3_learn may be input to the conversational feature extraction unit 221 as the results of the respective category classification (e.g., in the case of the learning speaking mannerism information CF1_learn, one of the calm type, soft type, energetic type, and passionate type), as described above.

In this case, the learning conversational features CF_learn may be used as answer data, i.e., labeling data. In other words, in the learning phase of the conversational feature extraction unit 221, the learning speaking mannerism information CF1_learn, the learning vocabulary information CF2_learn, and the learning standard language information CF3_learn input by the manager of the chatbot operation device 200 may be used as labeling data.

That is, the conversational feature extraction unit 221 may be trained in a supervised learning manner in which the learning lecture data LD_learn is input to the input terminal and the learning conversational features CF_learn are applied to the output terminal. However, this is merely one example and the present disclosure is not limited thereto.

As shown in <A2> of FIG. 7b, when lecture data LD_inference is input as input data in the inferencing phase, the conversational feature extraction unit 221 may output conversational features CF_inference corresponding to the lecture data LD_inference. In this case, the conversational features CF_inference may include speaking mannerism information CF1_inference, vocabulary information CF2_inference, and standard language information CF3_inference, as described above.

The description feature extraction unit 222 may extract the description features DF of the teacher in the corresponding online lecture based on the lecture data LD. In this case, the description features DF may refer to features related to the way the teacher delivers the lecture content while conducting the corresponding online lecture. In this case, the description feature extraction unit 222 may extract the description features DF based on the video data LD1 and the audio data LD2 included in the lecture data LD.

As one example, the description features DF may include the description method information, the description sequence information, etc., of the teacher. In other words, the description feature extraction unit 222 may extract at least one of the description method information and description sequence information of the teacher as the description features DF.

The description method information may include a storytelling method, an exemplification method, a visual materialization method, etc. In other words, the description method information may be categorized into the storytelling method, the exemplification method, the visual materialization method, etc. The storytelling method refers to a method of describing the background, main characters, development of events, and the like of a particular fact (e.g., a historical event) in a narrative format when the teacher conveys the corresponding fact, the exemplification method refers to a method of describing a particular topic or concept or the like by applying it to an everyday situation or the like when the teacher describes it, and the visual materialization method refers to a method of presenting audiovisual materials such as animations and videos rather than just describing in voice when the teacher describes a particular concept. In this case, the description feature extraction unit 222 may determine the description method information on the teacher as the storytelling method, exemplification method, visual materialization method, or the like by analyzing the video data LD1 and the audio data LD2 included in the lecture data LD (e.g., determining whether the video data LD1 includes visual materials, etc.).

The description sequence information may be information on which topic the teacher mentioned and described first out of a plurality of topics included in the lecture content of the corresponding online lecture. In other words, the description sequence information may refer to the sequence of mention for each of the plurality of topics included in the lecture content. In this case, the description sequence information may be categorized into a standardized method that follows the sequence of each unit pre-classified in a textbook, an unstandardized method that does not follow the sequence of each unit pre-classified in the textbook, etc.

In this case, the description feature extraction unit 222 may generate summarized data for the lecture data LD by using a predefined generative neural network (e.g., ChatGPT), compare the generated lecture data LD with the summarized data SD, and determine the description sequence information based on the comparison result. As one example, the description feature extraction unit 222 may determine the appearance position or appearance point of a topic (description topic) in each of the lecture data LD and the summarized data, and determine the description sequence information based on the determined appearance position or appearance point. For example, the description feature extraction unit 222 may determine the description sequence information of the corresponding teacher as the “standardized method” if the appearance positions of each topic in the lecture data LD and the summarized data match or are similar within a predefined threshold range, and may determine the description sequence information of the corresponding teacher as the “unstandardized method” if the appearance positions of each topic in the lecture data LD and the summarized data differ by the corresponding threshold range or greater. That is, the summarized data is data obtained by summarizing the entire data included in the lecture data LD, and thus includes the results obtained by excerpting and re-writing some data from the entire lecture data LD without being bound by the description sequence information of the teacher. Therefore, the summarized data is data written according to a general logical concept unrelated to the description sequence information of the teacher, e.g., the sequence of each unit pre-classified in the textbook and the like. Accordingly, the description feature extraction unit 222 may determine the description sequence information of the teacher in the corresponding lecture data LD as the standardized method if the description sequence information in the summarized data and the lecture data LD is similar, and on the contrary, may determine the description sequence information of the teacher as the unstandardized method if they are dissimilar.

FIG. 7c shows the learning phase and inferencing phase by the training module 260 of the description feature extraction unit 222. Specifically, <B1> of FIG. 7c shows the learning phase of the description feature extraction unit 222, and <B2> of FIG. 7c shows the inferencing phase of the description feature extraction unit 222.

As shown in <B1> of FIG. 7c, the description feature extraction unit 222 may be pre-trained by the training module 260 to output learning description features DF_learn based on the learning lecture data LD_learn when the learning lecture data LD_learn is input. That is, the description feature extraction unit 222 may use the learning lecture data LD_learn and the learning description features DF_learn as a training data set in the learning phase.

The learning description features DF_learn may include learning description method information DF1_learn and learning description sequence information DF2_learn.

In this case, the description feature extraction unit 222 may be trained in the learning process to generate learning summarized data from the learning lecture data LD_learn when the learning lecture data LD_learn is input, and to extract learning description features DF_learn by using the generated learning summarized data and learning lecture data LD_learn. That is, the description feature extraction unit 222 may be trained to output the learning description method information DF1_learn based on the learning lecture data LD_learn and may be trained to output the learning description sequence information DF2_learn based on the learning lecture data LD_learn and the learning summarized data when the learning lecture data LD_learn is input. In this case, the description feature extraction unit 222 may be trained to compare the learning lecture data LD_learn with the learning summarized data, and output the learning description sequence information DF2_learn based on the comparison result, as described above.

The learning description features DF_learn may be data input by the manager of the chatbot operation device 200. In other words, the learning description features DF_learn may be data input by the manager of the chatbot operation device 200 so as to match the lecture data LD_learn as learning data. In this case, the learning description method information DF1_learn and the learning description sequence information DF2_learn may be input to the description feature extraction unit 222 as the results of the respective category classification (e.g., in the case of the learning description method information DF1_learn, one of the storytelling method, exemplification method, and visual materialization method), as described above.

In this case, the learning description features DF_learn may be used as answer data, i.e., labeling data. In other words, in the learning phase of the description feature extraction unit 222, the learning description method information DF1_learn and learning description sequence information DF2_learn input by the manager of the chatbot operation device 200 may be used as labeling data.

That is, the description feature extraction unit 222 may be trained in a supervised learning manner in which the learning lecture data LD_learn is input to the input terminal and the learning description features DF_learn are applied to the output terminal. However, this is merely one example and the present disclosure is not limited thereto.

As shown in <B2> of FIG. 7c, when the lecture data LD_inference is input as input data in the inferencing phase, the description feature extraction unit 222 may output description features DF_inference corresponding to the lecture data LD_inference. In this case, the description features DF_inference may include description method information DF1_inference and description sequence information DF2_inference, as described above.

The entertainment feature extraction unit 223 may extract the entertainment features (hereinafter referred to as “EF”) of the teacher in the corresponding online lecture based on the lecture data LD. In this case, the entertainment features EF may refer to features related to the level of entertainment of the teacher in the corresponding online lecture. In this case, the entertainment feature extraction unit 223 may extract the entertainment features EF based on the audio data LD2 included in the lecture data LD. In this case, the audio data LD2 may include both the voice of the teacher and the voices of the students in the online lecture, as described above.

As one example, the entertainment features EF may include data related to the voice uttered by the teacher outside the lecture content in the online lecture, i.e., jokes, and information on the communication with the students according thereto. In other words, the entertainment feature extraction unit 223 may extract the joke information of the teacher and the reaction information on the reactions by the students to the jokes as the entertainment features EF.

The joke information may include data on the type and duration of the joke spoken by the teacher in the online lecture. As one example, the joke information may include the degree of relevance of the jokes of the teacher to the lecture content, the proportion of time the teacher joked that takes up in the total lecture time, etc.

The reaction information may include data on the degree to which the students reacted to the jokes of the corresponding teacher. As one example, the reaction information may include the laughter decibel magnitude, the duration of laughter, the total amount of laughter decibels in the corresponding online lecture, etc., of the students.

FIG. 7d shows the learning phase and inferencing phase by the training module 260 of the entertainment feature extraction unit 223. Specifically, <C1> of FIG. 7d shows the learning phase of the entertainment feature extraction unit 223, and <C2> of FIG. 7d shows the inferencing phase of the entertainment feature extraction unit 223.

As shown in <C1> of FIG. 7d, the entertainment feature extraction unit 223 may be pre-trained by the training module 260 to output learning entertainment features EF_learn based on the learning lecture data LD_learn when the learning lecture data LD_learn is input. That is, the entertainment feature extraction unit 223 may use the learning lecture data LD_learn and the learning entertainment features EF_learn as a training data set in the learning phase.

The learning entertainment features EF_learn may include learning joke information EF1_learn and learning reaction information EF2_learn.

The learning entertainment features EF_learn may be data input by the manager of the chatbot operation device 200. In other words, the learning entertainment features EF_learn may be data input by the manager of the chatbot operation device 200 so as to match the lecture data LD_learn as learning data. In this case, the learning joke information EF1_learn may include the degree of relevance of the jokes of the teacher to the lecture content, the proportion of time the teacher joked that takes up in the total lecture time, etc., as described above, and the learning reaction information EF2_learn may include the laughter decibel magnitude, the duration of laughter, the total amount of laughter decibels in the corresponding online lecture, etc., of the students.

In this case, the learning entertainment features EF_learn may be used as answer data, i.e., labeling data. In other words, in the learning phase of the entertainment feature extraction unit 223, the learning joke information EF1_learn and the learning reaction information EF2_learn input by the manager of the chatbot operation device 200 may be used as labeling data.

That is, the entertainment feature extraction unit 223 may be trained in a supervised learning manner in which the learning lecture data LD_learn is input to the input terminal and the learning entertainment features EF_learn are applied to the output terminal. However, this is merely one example and the present disclosure is not limited thereto.

As shown in <C2> of FIG. 7d, when the lecture data LD_inference is input as input data in the inferencing phase, the entertainment feature extraction unit 223 may output entertainment features EF_inference corresponding to the lecture data LD_inference. In this case, the entertainment features EF_inference may include joke information EF1_inference and reaction information EF2_inference, as described above.

Finally, the style determination module 220 may determine and output at least one of the generated conversational features CF, description features DF, and entertainment features EF as the teacher analysis data TAD.

Referring to FIGS. 1 and 3 to 6, the style determination module 220 may next receive a desired style, which is a style desired by the user, from the user terminal 103 (S120).

In this case, the desired style received from the user terminal 103 may include text data related to a selection by the user for one of a plurality of style types categorized and output to the user terminal 103 or a preferred style entered directly by the user.

Next, the style determination module 220 may determine the style information SI based on the teacher analysis data TAD and the desired style (S130).

As some examples, the style determination module 220 may calculate the cosine similarity between the teacher analysis data TAD for each of the plurality of teachers and the received desired style, and determine the teacher analysis data TAD having the maximum calculated cosine similarity as the style information SI.

The extraction and embedding of conversational, descriptive, and entertainment features from lecture data constitute a non-conventional use of machine learning within an educational chatbot. Unlike conventional systems, which use pre-scripted personas or manually assigned styles, this system employs supervised learning to model actual instructor behavior across multiple pedagogical dimensions. This represents a concrete improvement in the field of adaptive instructional technologies.

Referring to FIGS. 1 and 3 to 5, the chatbot operation device 200 may next output question data QD related to a predefined question to the user terminal 103 corresponding to the user (S200), and may next receive request for help data HD related to the question data QD from the user terminal 103 (S300).

As some examples, the output module 240 may output the question data QD to the user terminal 103 (S200), and in response thereto, the data collection module 210 may receive the request for help data HD entered by the user in relation to the question data QD from the user terminal 103.

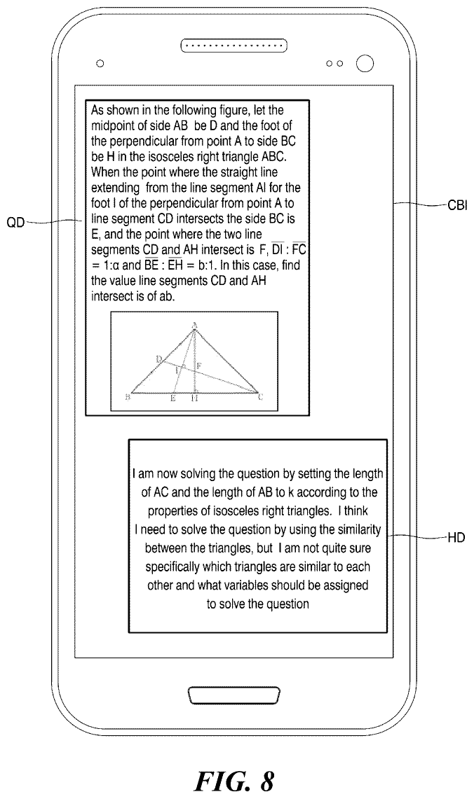

In the following, the process of outputting the question data and the process of receiving the request for help data according to some embodiments of the present disclosure will be described in detail with reference to FIG. 8.

FIG. 8 is a diagram for describing a step of outputting question data and a step of receiving request for help data according to some embodiments of the present disclosure.

Referring to FIGS. 1, 3 to 5, and 8, first, the output module 240 may output the question data QD onto a chatbot interface (hereinafter referred to as “CBI”) provided to the user terminal 103. That is, the output module 240 may provide the question data QD including a predefined question onto the chatbot interface CBI accessed by the user terminal 103.

Next, the data collection module 210 may receive the request for help data HD of the user on the chatbot interface CBI. In this case, the request for help data HD may include text data for requesting help related to solving the question via the chatbot interface CBI accessed by the user terminal 103 in order for the user to solve the question, as shown in FIG. 8.

Referring again to FIGS. 1 and 3 to 5, the chatbot operation device 200 may next generate a sequential guide SG for the user to reach the answer data corresponding to the question data QD, and provide the generated sequential guide SG according to the style information SI (S400).

In other words, the query generation module 230 may generate the sequential guide SG for the user to reach the answer data corresponding to the question data QD based on the request for help data HD, and the output module 240 may transform the sequential guide SG according to the style information SI specified by the user, and provide the sequential guide SG_SI according to the style information to the user terminal 103.

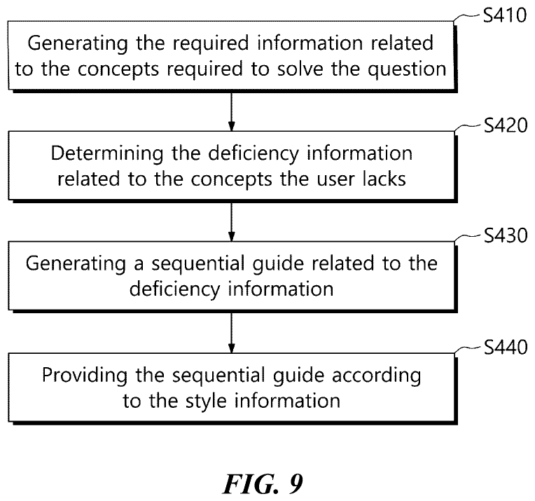

In the following, the process of providing the sequential guide SG_SI according to the style information will be described with reference to FIGS. 9 to 10f.

FIG. 9 is a detailed flowchart of a step of providing the sequential guide of FIG. 5 according to the style information. FIGS. 10a to 10f are diagrams for describing a process of providing the sequential guide according to the style information in accordance with some embodiments of the present disclosure. Each step (S410 to S440) of FIG. 9 may be performed by the chatbot operation device 200 and the sub-components included therein shown in FIGS. 1 and 3.

Referring to FIGS. 1, 3 to 5, 9, and 10a to 10f, the query generation module 230 may include an embedding unit 231 that converts each of the question data QD, the solution data AD, and the concept information CI into embedding vectors (hereinafter referred to as “EV”), a comparison unit 232 that defines required information (hereinafter referred to as “RI”) based on the embedding conversion result, a determination unit 233 that determines deficiency information (hereinafter referred to as “DI”) based on the required information RI, and a generation unit 234 that generates a sequential guide SG based on the deficiency information DI.

First, the query generation module 230 may generate the required information RI related to the concepts required to solve the question (S410).

As some examples, the query generation module 230 may define the required information RI related to the concepts required to solve the question by comparing the question data QD with the solution data AD related to the answer to the question. For example, the query generation module 230 may determine at least one concept of a plurality of concepts (e.g., C_1 to C_5 in FIG. 4c) included in the concept information CI, which includes a predefined concept set and a concept tree, and sub-concepts included therein as the required information RI by comparing the question data QD with the solution data AD.

More particularly, the embedding unit 231 may convert each of the question data QD, the solution data AD, and the concept information CI into embedding vectors EV, thereby generating a question embedding vector EV_QD, a solution embedding vector EV_AD, and a concept embedding vector EV_CI. In other words, the embedding unit 231 may convert each of the question data QD, the solution data AD, and the concept information CI into embedding vectors EV, thereby generating the question embedding vector EV_QD, the solution embedding vector EV_AD, and the concept embedding vector EV_CI represented in embedding spaces (hereinafter referred to as “ES”).

In this case, each of the question embedding vector EV_QD, the solution embedding vector EV_AD, and the concept embedding vector EV_CI may be in the form of a set of a plurality of sub-vectors.

Describing with FIG. 10b as an example, the embedding unit 231 may convert question data QD into a question embedding vector EV_QD represented in an embedding space ES_QD, and convert solution data AD into a solution embedding vector EV_AD represented in an embedding space ES_AD. Although not shown in FIG. 10b, it is obvious that the embedding unit 231 may convert concept information CI into a concept embedding vector EV_CI in a corresponding embedding space ES as well.

In this case, FIG. 10b shows for convenience of description that the embedding unit 231 has converted the word “perpendicular” out of the words included in the question data QD into a first question embedding vector EV_QD1, has converted the word “isosceles right triangle” into a second question embedding vector EV_QD2, has converted the word “similarity” out of the words included in the solution data AD into a first solution embedding vector EV_AD1, and has converted the word “center of gravity” into a second solution embedding vector EV_AD2. That is, the embedding unit 231 can extract features in the form of text or images from each of the question data QD, the solution data AD, and the concept information CI, and then generate embedding vectors EV_QD, EV_AD, and EV_CI represented in each embedding space ES based on the extracted features.

Further, the embedding unit 231 may generate the question embedding vector EV_QD, the solution embedding vector EV_AD, and the concept embedding vector EV_CI using a pre-trained embedding vector conversion algorithm. In this case, the embedding vector conversion algorithm is an algorithm that converts text and/or an image into an embedding vector when the corresponding text and/or image is input, and may include Word2Vec, BERT (Bidirectional Encoder Representations from Transformers) model, Siamese Networks, CLIP (Contrastive Language-Image Pre-training) model, or a combination thereof, but the embodiment of the present disclosure is not limited thereto. In this case, the training module 260 may train the embedding unit 231 to output the question embedding vector EV_QD, the solution embedding vector EV_AD, and the concept embedding vector EV_CI as training data based on the question data QD, the solution data AD, and the concept information CI as training data, in the “learning phase” of the embedding unit 231. In this case, the question embedding vector EV_QD, the solution embedding vector EV_AD, and the concept embedding vector EV_CI as training data may serve as answer data, i.e., labeling data, in the learning process of the embedding unit 231, and may be data provided for learning progress by the manager of the chatbot operation device 200.

The comparison unit 232 may define the required information RI based on the embedding conversion result of the embedding unit 231. In other words, the comparison unit 232 may determine at least one concept of the plurality of concepts (e.g., C_1 to C_5 in FIG. 4c) included in the concept information CI and the sub-concepts included therein as the required information RI based on the question embedding vector EV_QD, the solution embedding vector EV_AD, and the concept embedding vector EV_CI.

As some examples, the comparison unit 232 may determine the required information RI based on whether the question embedding vector EV_QD and the solution embedding vector EV_AD overlap with the concept embedding vector EV_CI.

For example, the comparison unit 232 may determine overlapping vectors that overlap with the question embedding vector EV_QD and the solution embedding vector EV_AD out of the concept embedding vector EV_CI, and may determine concepts corresponding to the overlapping vectors out of the plurality of concepts (e.g., C_1 to C_5 in FIG. 4c) and the sub-concepts included therein as the required information RI. In other words, the comparison unit 232 may determine a first overlapping vector that overlaps between the question embedding vector EV_QD and the concept embedding vector EV_CI, determine a second overlapping vector that overlaps between the solution embedding vector EV_AD and the concept embedding vector EV_CI, and determine a concept corresponding to each of the determined first overlapping vector and second overlapping vector as the required information RI.

Describing with FIG. 10b as an example, if it is assumed that the first question embedding vector EV_QD1 is included in the concept embedding vector EV_CI and the first solution embedding vector EV_AD1 is included in the concept embedding vector EV_CI, the comparison unit 232 can determine concepts such as “a perpendicular and similarity of figures,” which are concepts corresponding to the first question embedding vector EV_QD1 and the first solution embedding vector EV_AD1, as the required information RI.

The use of embedding vector comparison to match question and solution data with elements of a domain-specific concept hierarchy constitutes a non-abstract application of machine learning. Rather than merely returning data in response to queries, the system infers user deficiencies, maps them to conceptual elements, and generates sequential guidance. This method improves the technical functioning of chatbot systems by enabling context-sensitive, multi-step reasoning, which would not be possible using conventional rule-based or static architectures.

Next, the query generation module 230 may determine the deficiency information DI related to the concepts the user lacks (S420).

As some examples, the query generation module 230 may determine some of the required information RI as the deficiency information DI related to the concepts the user lacks based on the generated required information RI and the received request for help data HD. For example, the query generation module 230 may determine concepts corresponding to keywords included in the request for help data HD out of at least one piece of the required information RI as the deficiency information DI.

More particularly, the determination unit 233 may determine some of the required information RI as the deficiency information DI related to the concepts the user lacks based on the required information RI and the received request for help data HD. As some examples, the determination unit 233 may determine the concepts corresponding to the keywords included in the request for help data HD out of at least one piece of the required information RI as the deficiency information DI.

For example, the determination unit 233 may extract query features (hereinafter referred to as “QF”) from the request for help data HD and then determine the concepts corresponding to the query features QF extracted from the required information RI as the deficiency information DI. In this case, the query features QF may include features that are determined for the user to be ignorant of, i.e., not to know of, in the request for help data HD entered by the user. Describing by taking an example, since the text contained in the request for help data HD, such as “I am not quite sure specifically which triangles are similar to each other and what variables should be assigned to solve the question,” describes that the user does not know the concept of “similarity,” as shown in FIG. 10c, the determination unit 233 may determine the concept of “similarity” as the query feature QF, and determine the concept of “similarity” corresponding to the query feature QF extracted from the required information RI and the sub-concept of “similarity in isosceles right triangles” included therein as the deficiency information DI.

Next, the query generation module 230 may generate a sequential guide SG related to the deficiency information DI (S430), and the output module 240 may provide the sequential guide SG according to the style information SI (S440). That is, the output module 240 may post-process the vocabulary, speaking mannerism, content, etc., of the sequential guide SG according to the style information SI and provide the sequential guide SG_SI according to the style information to the user terminal 103.

More particularly, first, the generation unit 234 may generate query data SG1 related to whether the user is familiar with the deficiency information DI, as shown in FIG. 10d, and the output module 240 may provide the query data SG1 to the user terminal 103. In this case, the output module 240 may output the query data SG1 onto the chatbot interface CBI. In this case, the query data SG1 may also be referred to as the term “a first sequential guide.”

Next, the generation unit 234 may generate guide data (hereinafter referred to as “GD”) based on a user response (hereinafter referred to as “UR”) of the user terminal 103 to the query data SG1, and the output module 240 may output the guide data GD onto the chatbot interface CBI. In this case, the guide data GD may also be referred to as the term “a second sequential guide.”

As a first example, if the user terminal 103 has input a first user response UR1 indicating familiarity to the query data SG1 as shown in FIG. 10e, the generation unit 234 may generate first guide data GD1 that guides the user to solve the question data QD by using the deficiency information DI. In this case, the first guide data GD1 may be information that reminds the user of the deficiency information DI and prods the user to solve the question through the deficiency information DI. In this case, if the user terminal 103 has made a response of unawareness (a response indicating unfamiliarity) to the first guide data GD1, the user terminal 103 may provide second guide data GD2 as shown in FIG. 10f.

As a second example, if the user terminal 103 has input a second user response UR2 indicating unfamiliarity to the query data SG1 as shown in FIG. 10f, the generation unit 234 may generate the second guide data GD2 that provides a description of the deficiency information DI. In this case, the second guide data GD2 may be data that provides information on the deficiency information DI, which indicates the concepts the user lacks. For example, the second guide data GD2 may include content data describing the deficiency information DI, content data describing a higher-level concept of the deficiency information DI, and content data describing a similar concept to the deficiency information DI, as shown in FIG. 10f.

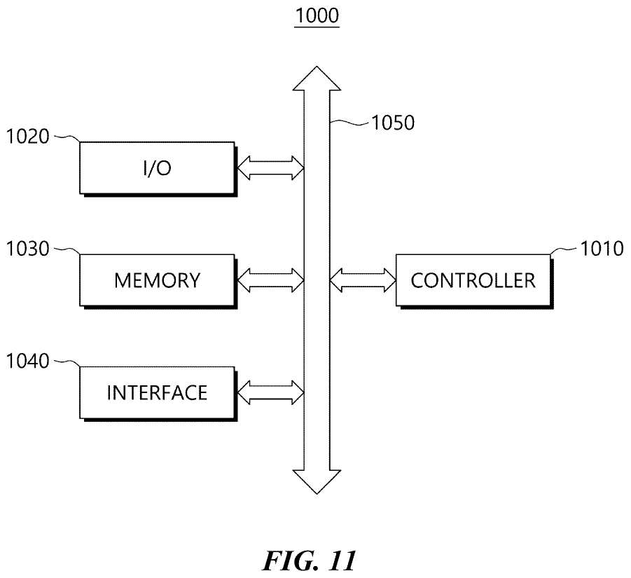

FIG. 11 is a diagram for describing a hardware implementation of a chatbot operation device that performs a teaching material analysis method according to some embodiments of the present disclosure.

Referring to FIGS. 1 and 11, the chatbot operation device 200 according to some embodiments of the present disclosure may be implemented in an electronic device 1000. The electronic device 1000 may include a controller 1010, an input/output device I/O 1020, a memory device 1030, an interface 1040, and a bus 1050. The controller 1010, the input/output device 1020, the memory device 1030, and/or the interface 1040 may be coupled to each other via the bus 1050. In this case, the bus 1050 corresponds to a path through which data is moved.

Specifically, the controller 1010 may include at least one of a central processing unit (CPU), a microprocessor unit (MPU), a microcontroller unit (MCU), a graphic processing unit (GPU), a microprocessor, a digital signal processor, a microcontroller, an application processor (AP), and logic devices capable of performing functions similar thereto.

The input/output device 1020 may include at least one of a keypad, a keyboard, a touch screen, and a display device.

The memory device 1030 may store data and/or a program, etc.

The interface 1040 may perform the function of transmitting data to a communication network or receiving data from the communication network. The interface 1040 may be of a wired or wireless form. For example, the interface 1040 may include an antenna, a wired/wireless transceiver, or the like. Although not shown, the memory device 1030 may be an operating memory for improving the operation of the controller 1010, which may further include a high-speed DRAM and/or SRAM, etc. The memory device 1030 may store a program or an application therein.

The chatbot operation device 200 according to the embodiments of the present disclosure may be a system formed by connecting a plurality of electronic devices 1000 to each other via a network. In such a case, each module or combinations of modules may be implemented in the electronic device 1000. However, the present embodiment is not limited thereto.

Additionally, the chatbot operation device 200 may be implemented in at least one of a workstation, a data center, an Internet data center (IDC), a direct-attached storage (DAS) system, a storage area network (SAN) system, a network-attached storage (NAS) system, a redundant array of inexpensive disks or redundant array of independent disks (RAID) system, and an electronic document management system (EDMS), but the present embodiment is not limited thereto.

Furthermore, the chatbot operation device 200 may transmit data to the external database 100 via a network. The network may include a network based on wired Internet technology, wireless Internet technology, and short-range communication technology. The wired Internet technology may include, for example, at least one of a local area network (LAN) and a wide area network (WAN).

The wireless Internet technology may include, for example, at least one of wireless LAN (WLAN), Digital Living Network Alliance (DMNA), Wireless Broadband (WiBro), World Interoperability for Microwave Access (WiMAX), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), and 5G New Radio (NR) technology. However, the present embodiment is not limited thereto.

The short-range communication technology may include, for example, at least one of Bluetooth, Radio Frequency Identification (RFID), Infrared Data Association (IrDA), Ultra-Wideband (UWB), ZigBee, Near Field Communication (NFC), Ultra Sound Communication (USC), Visible Light Communication (VLC), Wi-Fi, Wi-Fi Direct, and 5G New Radio (NR). However, the present embodiment is not limited thereto.

The chatbot operation device 200 communicating over a network may comply with technical standards and standard communication methods for mobile communication. For example, the standard communication methods may include at least one of Global System for Mobile communication (GSM), Code Division Multiple Access (CDMA), Code Division Multiple Access 2000 (CDMA 2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), and 5G New Radio (NR). However, the present embodiment is not limited thereto.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. It is therefore desired that the embodiments be considered in all respects as illustrative and not restrictive, reference being made to the appended claims rather than the foregoing description to indicate the scope of the disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating a chatbot, performed by a chatbot operation device, comprising:
determining style information related to a style of responding to a query of a user;
outputting question data related to a predefined question to a user terminal corresponding to the user;
receiving request for help data related to the question data from the user terminal; and
generating a sequential guide for the user to reach answer data corresponding to the question data based on the request for help data, and providing the generated sequential guide according to the style information.

2. The method of claim 1, wherein the determining the style information comprises:
generating teacher analysis data for each of a plurality of teachers conducting online lectures based on lecture data related to the online lectures;
receiving a desired style, which is a style desired by the user, from the user terminal; and
determining the style information based on the teacher analysis data and the desired style.

3. The method of claim 2, wherein the determining the style information based on the teacher analysis data and the desired style:
calculates a cosine similarity between each of the plurality of teacher analysis data and the desired style, and
determines teacher analysis data having a maximum calculated cosine similarity as the style information.

4. The method of claim 2, wherein the generating the teacher analysis data comprises:
generating the teacher analysis data by analyzing features of a teacher conducting the online lecture by using a pre-trained neural network.

5. The method of claim 4, wherein the generating the teacher analysis data by analyzing the features of the teacher comprises:
extracting conversational features related to a voice of the teacher based on the lecture data;
extracting description features related to a delivery method of lecture content of the teacher based on the lecture data;
extracting entertainment features related to a level of entertainment of the teacher based on the lecture data; and
determining at least one of the conversational features, the description features, and the entertainment features as the teacher analysis data.

6. The method of claim 5, wherein the providing the sequential guide according to the style information comprises:
generating required information related to concepts required to solve the question by comparing the question data with solution data related to an answer to the question;
determining some of the generated required information as deficiency information related to concepts the user lacks based on the request for help data;
generating the sequential guide based on the deficiency information; and
providing the sequential guide according to the style information.

7. The method of claim 6, wherein the generating the required information comprises:
determining at least one concept of a plurality of concepts included in concept information including a predefined concept set and a concept tree as the required information by comparing the question data with the solution data.

8. The method of claim 6, wherein the determining some of the generated required information as the deficiency information related to the concepts the user lacks comprises:
determining concepts corresponding to keywords included in the request for help data out of at least one piece of the required information as the deficiency information.

9. The method of claim 6, wherein the providing the sequential guide according to the style information comprises:
providing query data regarding whether the user is familiar with the deficiency information to the user terminal; and
providing, to the user terminal, first guide data that guides the user to solve the question data by using the deficiency information or second guide data that provides a description of the deficiency information, based on a response by the user terminal to the query data.

10. The method of claim 9, wherein the providing the second guide data to the user terminal comprises:
providing, to the user terminal, content data describing at least one of the deficiency information, a higher-level concept of the deficiency information, and a similar concept to the deficiency information.
